(19) United States
(12) Patent Application Publication
(10) Pub. No.: US 2025/0322668 A1
(43) Pub. Date: Oct. 16, 2025

(54) TEMPORAL MULTI-FRAME OCCUPANCY ESTIMATION

(71) Applicant: GM GLOBAL TECHNOLOGY OPERATIONS LLC, DETROIT, MI (US)

(72) Inventors: Michael Baltaxe, Kfar Saba (IL); Dan Levi, Ganei Tikvah (IL)

(21) Appl. No.: 18/632,838

(22) Filed: Apr. 11, 2024

(51) Int. Cl. G06V 20/58; G06V 10/40; G06V 10/764

(52) U.S. Cl. CPC G06V 20/58; G06V 10/40; G06V 10/764

(57) ABSTRACT

Examples described herein provide a method that includes receiving a first image captured by a camera of a vehicle at a first time t and receiving a second image captured by the camera of the vehicle at a second time t-1. The method further includes projecting each of a plurality of world voxels to the camera at the first time t and the second time t-1. The method further includes aggregating voxel features for the plurality of world voxels for the first image and the second image. The method further includes training an occupancy classifier using the aggregated voxel features.

The subject disclosure relates to vehicles, and in particular to temporal multi-frame occupancy estimation.

Modern vehicles (e.g., a car, a motorcycle, a boat, or any other type of automobile) may be equipped with various sensors, such as cameras, proximity sensors, radio detection and ranging (radar) sensors, light detecting and ranging (LiDAR) device(s), and/or the like to collect data about an environment. Data, such as images, collected by these sensors can be used to perform perception tasks.

Perception tasks can include one or more of object detection, classification, tracking, lane detection, road sign recognition, and obstacle avoidance. Perception tasks are particularly useful for an autonomous vehicle to provide the autonomous vehicle with real-time awareness of its environment to make safe and informed driving decisions. Images from the one or more cameras of the vehicle can be used for detecting objects, tracking targets, and/or the like, including combinations and/or multiples thereof.

### SUMMARY

In one embodiment, a method is provided. The method includes receiving a first image captured by a camera of a vehicle at a first time t and receiving a second image captured by the camera of the vehicle at a second time t-1. The method further includes projecting each of a plurality of world voxels to the camera at the first time t and the second time t-1. The method further includes aggregating voxel features for the plurality of world voxels for the first image and the second image. The method further includes training an occupancy classifier using the aggregated voxel features.

In addition to one or more of the features described herein, or as an alternative, further embodiments of the method may include that projecting each of a plurality of world voxels to the camera at the first time t and the second time t-1 includes: extracting a feature from the first image captured at the first time t; projecting a voxel grid definition in a local coordinate system at the first time t to the first image; and performing feature sampling for the first image based at least in part on results of the extracting and results of the projecting.

In addition to one or more of the features described herein, or as an alternative, further embodiments of the method may include that projecting each of a plurality of world voxels to the camera at the first time t and the second time t-1 further includes: extracting the feature from the second image captured at the second time t-1; projecting the voxel grid definition in the local coordinate system at the second time t-1 to the second image; and performing feature sampling for the second image based at least in part on results of the extracting and results of the projecting.

In addition to one or more of the features described herein, or as an alternative, further embodiments of the method may include that projecting each of a plurality of world voxels to the camera at the first time t and the second time t-1 further includes: performing voxel feature aggregation based at least in part on results of the feature sampling for the first image and results of the feature sampling for the second image; and wherein training the occupancy classifier comprises generating an occupancy estimation network based at least in part on the voxel feature aggregation.

In addition to one or more of the features described herein, or as an alternative, further embodiments of the method may include that the occupancy estimation network is generated using voxel grid features.

In addition to one or more of the features described herein, or as an alternative, further embodiments of the method may include that the voxel feature aggregation is performed using at least one of an average, a weighted average, or a deformable attention.

In addition to one or more of the features described herein, or as an alternative, further embodiments of the method may include that training the occupancy classifier includes comparing voxel grid features to a ground truth value to reduce a cost function associated with the occupancy classifier.

In addition to one or more of the features described herein, or as an alternative, further embodiments of the method may include that the ground truth value is captured by a sensor associated with the vehicle.

In addition to one or more of the features described herein, or as an alternative, further embodiments of the method may include that the sensor is one of a range detection and ranging (radar) sensor and a light detecting and ranging (LiDAR) sensor.

In another embodiment, a vehicle is provided. The vehicle includes a camera capturing a first image at a first time t and a second image at a second time t-1. The vehicle also includes a processing system. The processing system includes a memory having computer readable instructions and a processing device for executing the computer readable instructions. The computer readable instructions control the processing device to perform operations. The operations include generating, using a trained occupancy classifier, a first occupancy estimation for voxels of the first image captured at the first time t. The operations further include generating, using the trained occupancy classifier, a second occupancy estimation for voxels of the second image captured at the second time t-1. The operations further include identifying, using the first occupancy estimation and the second occupancy estimation, anchor voxels, the anchor voxels being voxels of the first image and the second image that are static and have a probability of occupancy exceeding a threshold. The operations further include extracting, from the anchor voxels, voxels of the first image and the second image within a threshold distance of the anchor voxels as extracted voxels. The operations further include generating a noise reduced occupancy estimation for voxels of the first image and voxels of the second image using the anchor voxels and the extracted voxels within the threshold distance of the anchor voxels.

In addition to one or more of the features described herein, or as an alternative, further embodiments of the vehicle may include that identifying the anchor voxels includes: transforming the first occupancy estimation to first coordinates of a global coordinate system to generate a first point cloud; transforming the second occupancy estimation to second coordinates of the global coordinate system to generate a second point cloud; and aggregating the first point cloud and the second point cloud into a combined point cloud.

In addition to one or more of the features described herein, or as an alternative, further embodiments of the vehicle may include that identifying the anchor voxels further includes: estimating a voxel density of the combined point cloud; comparing the voxel density to a density threshold; and identifying as the anchor voxels those voxels of the combined point cloud that exceed the density threshold.

In addition to one or more of the features described herein, or as an alternative, further embodiments of the vehicle may include that estimating the voxel density is based on a count of a number of times each voxel is occupied for the first time t and the second time t-1.

In addition to one or more of the features described herein, or as an alternative, further embodiments of the vehicle may include that estimating the voxel density is based on a kernel density estimation.

In addition to one or more of the features described herein, or as an alternative, further embodiments of the vehicle may include that transforming the first occupancy estimation to the first coordinates and transforming the second occupancy estimation to the second coordinates comprises applying runtime kinematics.

In addition to one or more of the features described herein, or as an alternative, further embodiments of the vehicle may include that transforming the first occupancy estimation to the first coordinates and transforming the second occupancy estimation to the second coordinates comprises applying visual simultaneous localization and mapping.

In another embodiment a computer program product is provided. The computer program product includes a computer readable storage medium having program instructions embodied therewith, the program instructions executable by at least one processor to cause the at least one processor to perform operations. The operations include generating, using a trained occupancy classifier, a first occupancy estimation for voxels of a first image captured by a camera of a vehicle at a first time t. The operations further include generating, using the trained occupancy classifier, a second occupancy estimation for voxels of a second image captured by the camera of the vehicle at a second time t-1. The operations further include identifying, using the first occupancy estimation and the second occupancy estimation, anchor voxels, the anchor voxels being voxels of the first image and the second image that are static and have a probability of occupancy exceeding a threshold. The operations further include extracting, from the anchor voxels, voxels of the first image and the second image within a threshold distance of the anchor voxels as extracted voxels. The operations further include generating a noise reduced occupancy estimation for voxels of the first image and voxels of the second image using the anchor voxels and the extracted voxels within the threshold distance of the anchor voxels.

In addition to one or more of the features described herein, or as an alternative, further embodiments of the computer program product may include that identifying the anchor voxels includes: transforming the first occupancy estimation to first coordinates of a global coordinate system to generate a first point cloud; transforming the second occupancy estimation to second coordinates of the global coordinate system to generate a second point cloud; and aggregating the first point cloud and the second point cloud into a combined point cloud.

In addition to one or more of the features described herein, or as an alternative, further embodiments of the computer program product may include that identifying the anchor voxels further includes: estimating a voxel density of the combined point cloud; comparing the voxel density to a density threshold; and identifying as the anchor voxels those voxels of the combined point cloud that exceed the density threshold.

In addition to one or more of the features described herein, or as an alternative, further embodiments of the computer program product may include that estimating the voxel density is based on a count of a number of times each voxel is occupied for the first time t and the second time t-1.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustration of a vehicle having a processing system for performing temporal multi-frame occupancy estimation for voxels of a scene according to one or more embodiments;

FIG. 2 is a block diagram of the processing system of FIG. 1 for performing temporal multi-frame occupancy estimation for voxels of a scene according to one or more embodiments;

FIG. 3 is a block diagram of an environment for performing temporal multi-frame occupancy estimation alignment for voxels of a scene according to one or more embodiments;

FIG. 4 is a flow diagram of a method for training a model for performing temporal multi-frame occupancy estimation alignment for voxels of a scene according to one or more embodiments;

FIG. 5 is a block diagram of the vehicle of FIG. 1 capturing images at various times using multiple cameras according to one or more embodiments;

FIG. 6 is a flow diagram of a method for voxel feature aggregation and occupancy estimation;

FIG. 7 is a flow diagram of a method for temporal aggregation with noise reduction according to one or more embodiments;

FIG. 8 is a flow diagram of a method for temporal aggregation with noise reduction according to one or more embodiments;

FIG. 9 is flow diagram of a method for identifying anchor voxels according to one or more embodiments;

FIG. 10 is a block diagram of components of a machine learning training and inference system according to one or more embodiments described herein; and

FIG. 11 is a block diagram of a processing system for implementing one or more embodiments described herein.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments described herein relates to temporal multi-frame occupancy estimation. Such embodiments enable perception tasks to be performed more efficiently on autonomous vehicles.

Autonomous vehicles include one or more sensors (e.g., cameras, LiDAR sensor, and/or the like, including combinations and/or multiples thereof) to collect data, such as images, that are then used to perform perception tasks. Perception tasks can include one or more of object detection, classification, tracking, lane detection, road sign recognition, and obstacle avoidance. Perception tasks are particularly useful for an autonomous vehicle to provide the autonomous vehicle with real-time awareness of its environment to make safe and informed driving decisions.

One or more sensors (e.g., a camera) of a vehicle can capture one or more images of a real-world environment around the vehicle, and a digital representation of that real-world environment can be recreated using the information (e.g., images) captured by the sensor(s). The digital representation of the real-world environment can be expressed in three dimensions (3D), with the digital representation made up of voxels. A voxel represents a value on a regular grid in 3D space. In some perception tasks, it is desirable to determine whether a voxel of a digital representation of a real-world environment is occupied by an object of interest (e.g., a vehicle). A digital representation of a real-world environment can also be referred to as a “real-world scene” or simply as a “scene.” In some cases, a voxel may appear to be occupied but the contents of the voxel are caused by noise or other undesirable effects.

One or more embodiments described herein address these and other shortcomings by improving occupancy estimation by using temporal information. Temporal information includes the use of multiple temporal frames (e.g., images captured in succession or periodically over a period of time) to aggregate voxel features across the scene in time, providing consistent information to disambiguate the occupancy status of a voxel. As used herein, the terms “frame” and “image” can be used interchangeably and both refer to a visual representation captured by a camera. A frame or image can be a single visual representation captured by an image (e.g., a still image) or can be a single visual representation extracted from a video (e.g., a frame extracted from a video). According to one or more embodiments, multiple temporal camera frames can be combined as input to an occupancy estimation network to estimate whether a voxel is occupied.

One or more embodiments described herein provide for inferring multiple frames throughout time to achieve a temporally consistent output. For example, occupancy frames can be inferred through time and are aggregated to define regions with high and low probability of being occupied. Such regions, together with an on-line estimated frame, are used to perform robust occupancy estimation, reducing the noise levels inherent in single frame estimation.

It should be appreciated that the functioning of any autonomous vehicle implementing one or more of the embodiments described herein is improved. For example, occupancy estimation is improved through the use of multi-frame information. By providing more accurate occupancy estimation, the vehicle can operate more efficiently by avoiding obstacles, for example. According to one or more embodiments, occupancy estimation is further improved by reducing the effects of occlusions, noise, and/or the like, including combinations and/or multiples thereof.

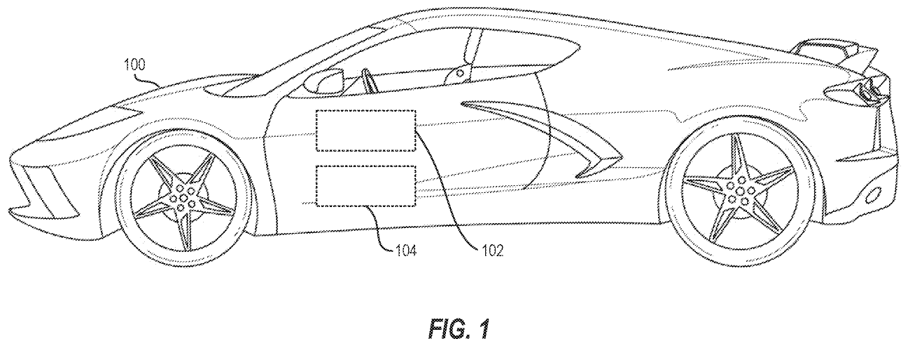

FIG. 1 is an illustration of a vehicle 100 having a processing system 102 for performing temporal multi-frame occupancy estimation for voxels of a scene according to one or more embodiments. The vehicle 100 can be a car, a truck, a van, a bus, a motorcycle, a boat, or any other type of automobile. According to an embodiment, the vehicle 100 includes an internal combustion engine fueled by gasoline, diesel, or the like. According to another embodiment, the vehicle 100 is a hybrid electric vehicle partially or wholly powered by electrical power. According to another embodiment, the vehicle 100 is an electric vehicle powered by electrical power.

According to one or more embodiments, the vehicle 100 is an autonomous vehicle and includes the processing system 102 and a camera 104. According to one or more embodiments, the vehicle 100 can include additional components and systems, which are not shown for brevity. For example, the vehicle 100 can include other sensors, such as LiDAR sensors, radar sensors, and/or the like, including combinations and/or multiples thereof. It should be appreciated that the camera 104 represents one or more cameras. That is, the vehicle 100 can include a single camera or multiple cameras.

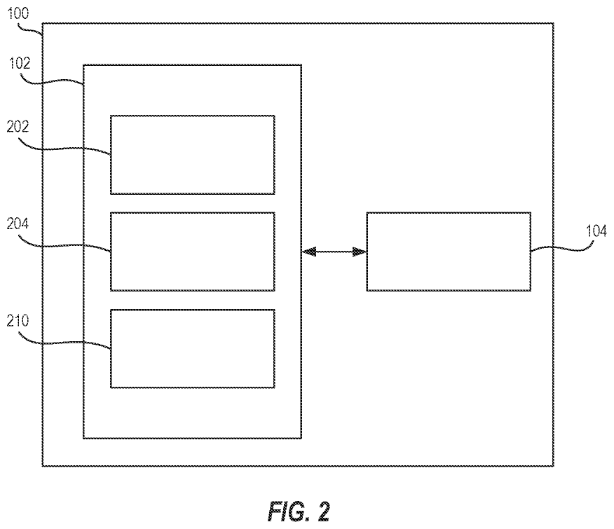

An autonomous vehicle is a vehicle that has self-driving capabilities. For example, the vehicle 100 includes sensors, such as the camera 104, that send data to the processing system 102. The processing system 102 can be programmed to navigate and operate the vehicle 100 without human intervention and/or with limited human intervention. The processing system 102 can include hardware and/or software to control the vehicle 100. For example, the processing system 102 can include processing resources for processing data and executing instructions, memory resources for storing data and instructions, data storage resources for storing data, communications resources for transmitting and receiving information, and/or the like, including combinations and/or multiples thereof. FIG. 2 shows an example of the processing system 102 and is discussed in more detail herein.

The processing system 102 can use information collected from the camera 104 to perform temporal multi-frame occupancy estimation, as is further described herein. For example, the processing system 102 can use images/frames from multiple cameras (e.g., multiple of the camera 104) to reconstruct a 3D scene and determine occupancy of individual voxels of the 3D scene. According to one or more embodiments, the camera 104 gathers images/frames at different time steps, which are used to extract visual features. The processing system 102 can aggregate the extracted visual features to obtain clean, stable information about the 3D scene. According to one or more embodiments, features are used to reconstruct the 3D scene using a trained machine learning model (e.g., a trained neural network) as described herein. For example, a trained neural network can estimate occupancy information at different time points; the estimated occupancy information can be used to estimate a confidence score of each voxel regarding whether the voxel is occupied. The confidence score can be used to mark the voxels as having a relatively high probability of being occupied, a relatively low probability of being occupied, and/or the like. Voxels with a relatively high probability of being occupied or a relatively low probability of being occupied are combined with a current inferred image/frame to extract enhanced occupancy estimation for the voxels that includes dynamic objects and voxels high with a probability of occupancy, while removing voxels having a relatively low probability of occupancy.

FIG. 2 is a block diagram of the processing system 102 of FIG. 1 for performing temporal multi-frame occupancy estimation for voxels of a scene according to one or more embodiments. The processing system 102 includes a processing device 202, a memory 204, and an occupancy engine 210. It should be appreciated that the processing system 102 can be any device suitable for performing a temporal multi-frame occupancy estimation. For example, the processing system 102 can be a device implemented in or otherwise associated with the vehicle 100. As another example, the processing system 102 can be a smartphone, tablet computer, laptop computer, desktop computer, wearable computing device, and/or the like, including combinations and/or multiples thereof.

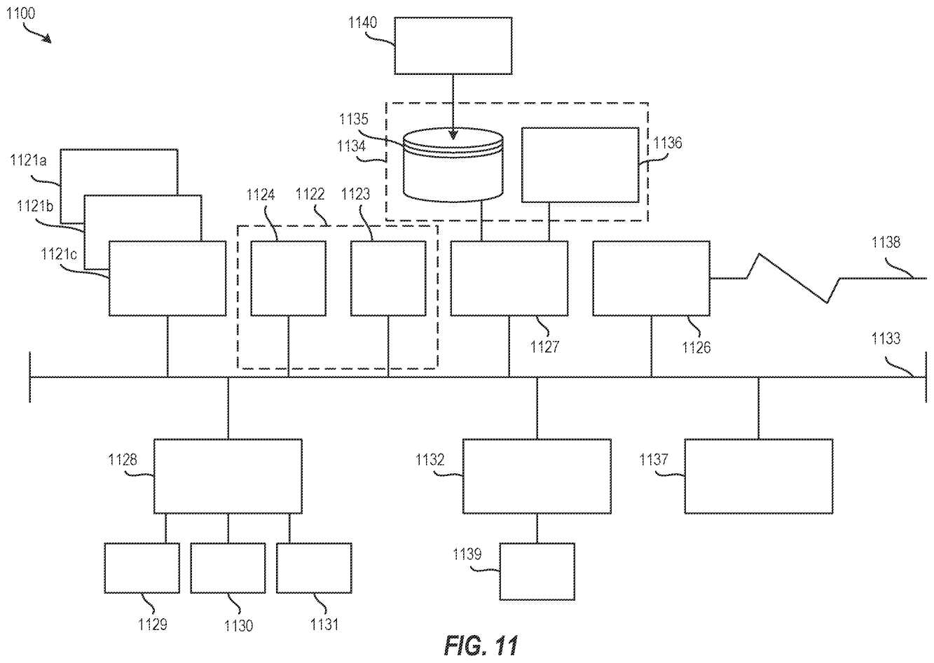

The processing device 202 is any suitable processing circuitry for processing data and/or instructions. The processing device 202 is an example of one or more of the processing devices 1121 of FIG. 11, as described in more detail herein.

The memory 204 is any suitable device for storing data and/or instructions. The memory 204 is an example of one or more of the system memory 1122, the random access memory 1123, and/or the read-only memory 1124 of FIG. 11, as described in more detail herein.

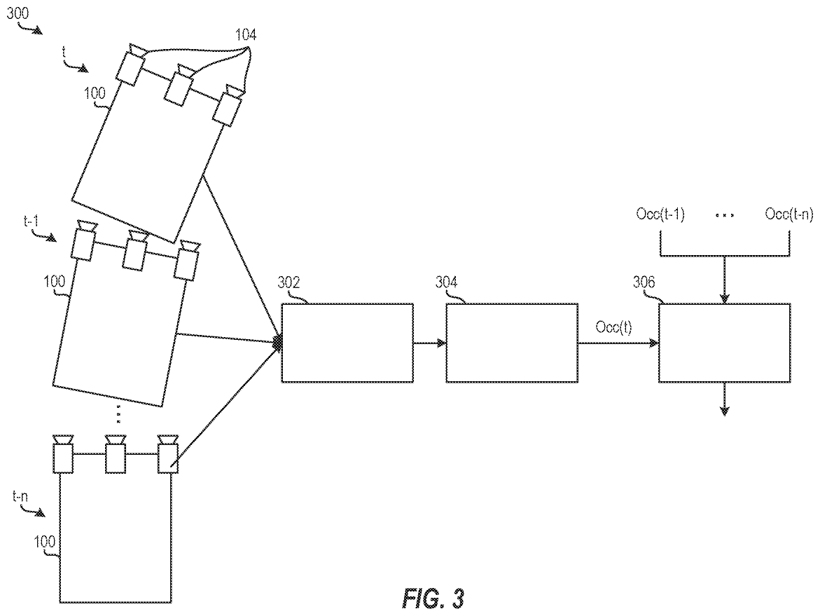

The occupancy engine 210 performs temporal multi-frame occupancy estimation for voxels of a scene, as described in more detail herein. Further aspects and features of the occupancy engine 210 are described herein with respect to FIGS. 3-10.

The various components, modules, engines, etc. described regarding FIG. 2 (e.g., the occupancy engine 210) can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the processing device 202 for executing those instructions. Thus a system memory (e.g., memory 204) can store program instructions that when executed by the processing device 202 implement the engines described herein. Other engines can also be utilized to include other features and functionality described in other examples herein.

FIG. 3 is a block diagram of an environment 300 for performing temporal multi-frame occupancy estimation alignment for voxels of a scene according to one or more embodiments. In this example, blocks 302, 304, and 306 are functional blocks representing functions performed by the occupancy engine 210 of FIG. 2.

Cameras 104 of the vehicle 100 capture images over time. For example, at a first time t, the vehicle 100 captures an image with each of the cameras 104. Although the vehicle 100 is shown as having three cameras 104, the vehicle 100 can have more or fewer cameras in other embodiments. At a second time t-1, which occurs prior to the first time t, the vehicle 100 captures an image with each of the cameras 104. That is, the vehicle 100 can capture images with the cameras 104 at successive times t . . . t-n, where “n” is any suitable integer. According to one or more embodiments, the value for n may be about five, although other values of n are possible. As the number of cameras on a vehicle increases, the number n of successive times can be decreased without compromising accuracy of the temporal occupancy estimation described herein.

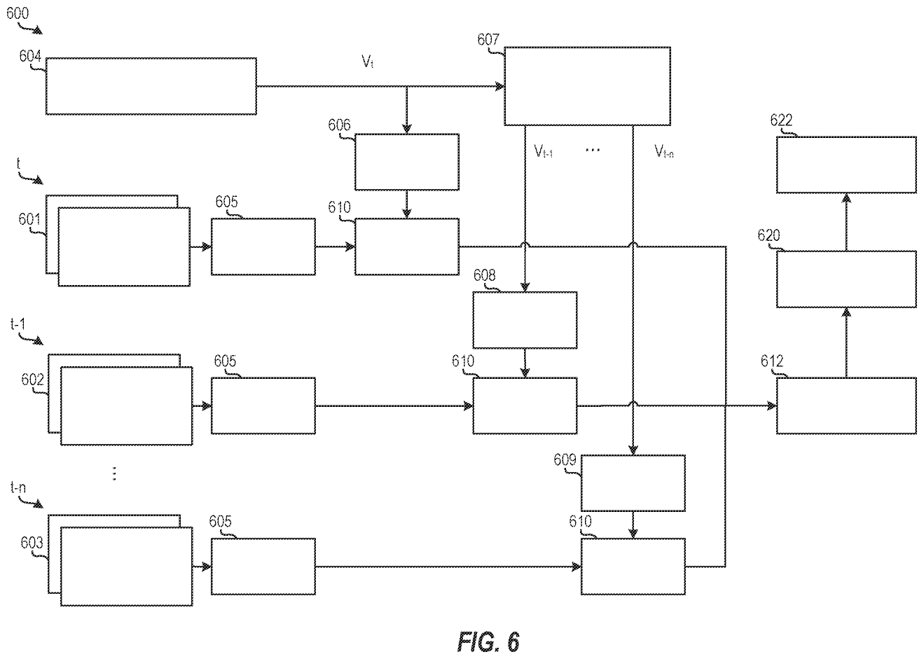

At block 302, the occupancy engine 210 performs voxel feature aggregation. At block 304, the occupancy engine 210 performs occupancy estimation using an occupancy classifier (see, e.g., FIG. 6) to estimate an occupancy at the first time t, referred to as “Occ(t).” The vehicle 100 estimates the occupancy for each of the times t . . . t-n by performing the voxel feature aggregation (block 302) and the occupancy estimation (block 304) to generate estimated occupancies for each of the times t . . . t-n, referred to as “Occ(t)” . . . “Oct(n)” respectively. At block 306, the occupancy engine 210 performs occupancy aggregation to aggregate the occupancy estimations from each of the times t . . . t-n and generate a temporal occupancy estimation, which is an estimate of which voxels are occupied and which voxels are not occupied, as further described herein. Voxel feature aggregation (block 302) and occupancy estimation (block 304) are described in more detail herein with reference to FIG. 6.

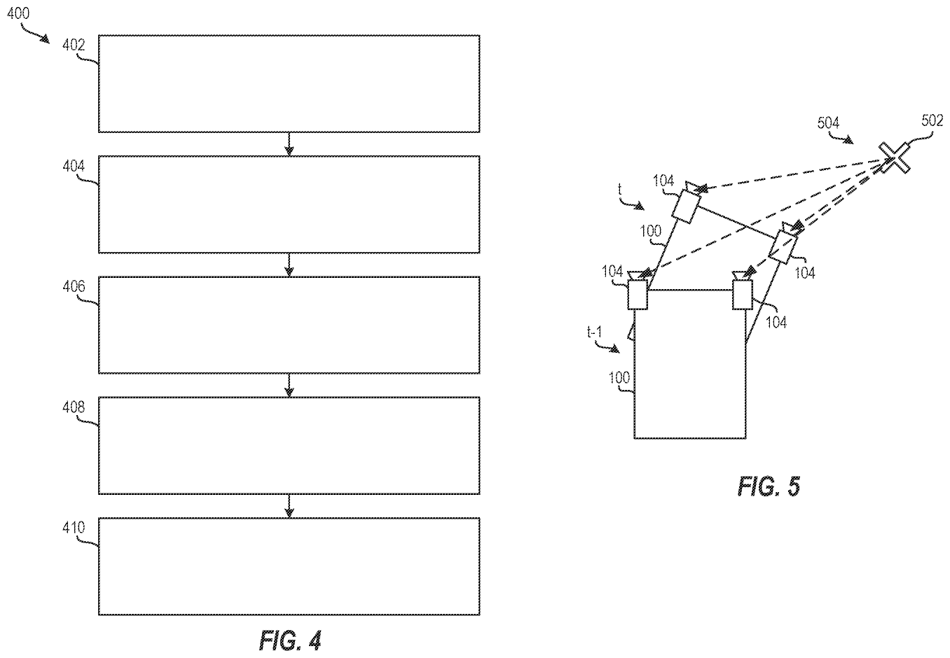

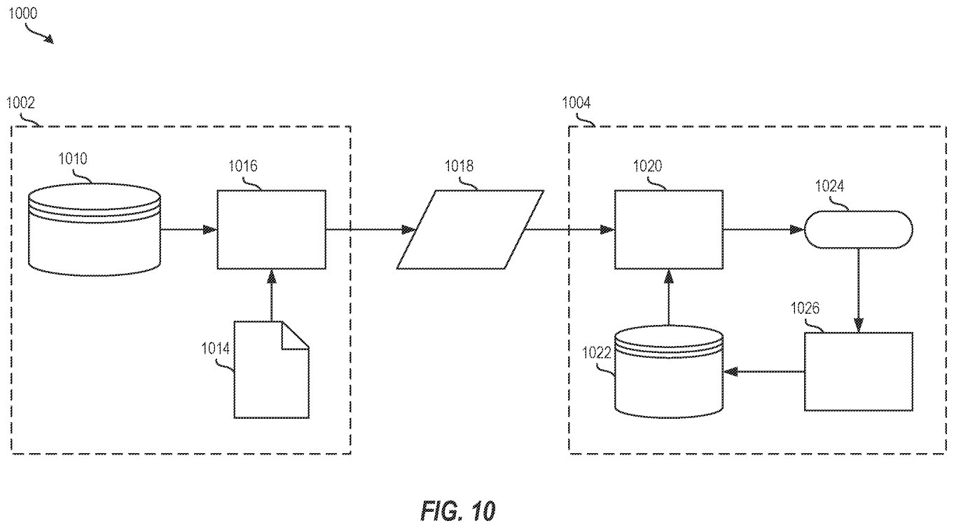

FIG. 4 is a flow diagram of a method 400 for training a model for performing temporal multi-frame occupancy estimation alignment for voxels of a scene according to one or more embodiments. The method 400 can be implemented using any suitable system or device. For example, the method 400 can be implemented, in whole or in part, using the processing system 102 of FIGS. 1 and 2, using the machine learning training and inference system 1000 of FIG. 10, and/or using the processing system 1100 of FIG. 1, and/or the like, including combinations and/or multiples thereof. The method 400 is now described with reference to FIGS. 1, 2, 5, and 6 but is not so limited. Particularly, FIG. 5 depicts the vehicle 100 capturing images at various times using multiple cameras (e.g., multiples of the camera 104) according to one or more embodiments. The cameras 104 of the vehicle 100 capture images of an object 502 (e.g., a vehicle) within an environment 504 as the vehicle moves over time from time t-1 to time t. FIG. 6 depicts a flow diagram of a method 600 for voxel feature aggregation and occupancy estimation according to one or more embodiments. The method 600 can be implemented using any suitable system or device. For example, the method 600 can be implemented, in whole or in part, using the processing system 102 of FIGS. 1 and 2, using the machine learning training and inference system 1000 of FIG. 10, and/or using the processing system 1100 of FIG. 1, and/or the like, including combinations and/or multiples thereof. Aspects of FIGS. 5 and 6, including the method 600, are now described with reference to FIG. 4.

Turning now to FIG. 4, at block 402, a first image 601 captured by the camera 104 of the vehicle 100 at a first time t is received. According to one or more embodiments, multiple cameras can be used to capture multiple images at the first time t, as shown in FIG. 5. At block 404, a second image 602 captured by the camera 104 of the vehicle 100 at a second time t-1 is received. According to one or more embodiments, multiple cameras can be used to capture multiple images at the second time t-1, as shown in FIG. 5. The first image 601 and the second image 602 can be used to train an occupancy classifier 620 and/or to generate an occupancy estimation 622 using the occupancy classifier 620, both of which are described in more detail herein. According to one or more embodiments, additional images 603 can be captured at prior points in time, such as at time t-n. Feature extraction 605 is performed on each of the images 601, 602, 603 to extract features (e.g., features of a target vehicle) from the images 601, 602, 603 at the different times t . . . t-n.

With continued reference to FIG. 4, at block 406, each of a plurality of world voxels are projected to the camera 104 at the first time t and the second time t-1. To do this, a voxel grid definition 604 (denoted Vₜ) in a local coordinate system of the vehicle 100 is projected onto the images captured by the camera 104 of the vehicle 100 at the various times t . . . t-n. For example, at block 606, the voxel grid definition 604 (Vₜ) is projected onto the image 601.

The voxel grid definition Vₜ at the first time t is projected, at block 606, onto the first image 601 captured by the camera 104 at the first time t. The voxel grid definition is transformed at block 607 to the local coordinate system of the vehicle 100 at prior points in time t-1 . . . t-n similarly, denoted Vₜ₋₁ . . . . Vₜ₋ₙ). Once the voxel grid definitions have been transformed, the voxel grid definition Vₜ₋₁ . . . . Vₜ₋ₙ are projected on images (e.g., the images 602, 603) at the proceeding times t-1 . . . t-n respectively at blocks 608 and 609.

With continued reference to FIG. 4, at block 408, voxel features for the plurality of world voxels are aggregated across the cameras 104 and the plurality of images 603. For example, referring to FIG. 6, at each of the times t . . . t-n, feature sampling 610 is performed. Feature sampling involves projecting the 3D location of each voxel to the 2D image using the extrinsic (rotation and translation with respect to the world coordinate system) and intrinsic (focal distance and principal point) calibration of the camera, and interpolating the image features at the calculated 2D location. Voxel feature aggregation 612 is performed using results of the feature sampling 610. The voxel features can be aggregated using any suitable statistical technique, such as average, weighted average, deformable attention, and/or the like, including combinations and/or multiples thereof. The voxel feature aggregation 612 generates voxel grid features.

With continued reference to FIG. 4, at block 410, the processing system 102 trains an occupancy classifier using the aggregated voxel features. For example, in FIG. 6, voxel features from the voxel feature aggregation 612 are used as training data to train the occupancy classifier 620. The occupancy classifier 620 can be any suitable machine learning architecture for performing classification tasks. One non-limiting example of such a classifier architecture is a convolutional neural network (CNN), although other suitable machine learning architectures are possible. Further details of training the occupancy classifier 620 are described herein with reference to FIG. 10. The occupancy classifier 620 can be used to generate an occupancy estimation 622 as further described herein. To train the occupancy classifier 620, a ground truth value can be used. For example, a predicted classification (e.g., the occupancy estimation 622) is compared to a ground truth value, and the results of the comparison can be used to train the occupancy classifier 620 by reducing a cost function, for example. The ground truth value can be captured by another sensor of the vehicle 100, such as a radar sensor, a LiDAR sensor, and/or the like, including combinations and/or multiples thereof.

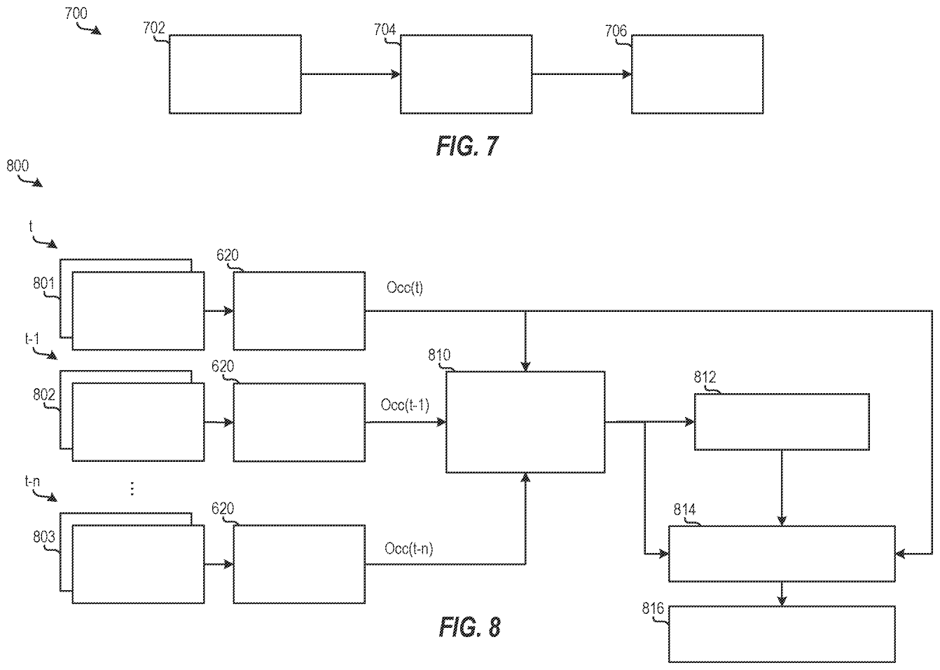

FIG. 7 depicts a flow diagram of a method 700 for temporal aggregation with noise reduction according to one or more embodiments. The method 700 can be implemented using any suitable system or device. For example, the method 700 can be implemented, in whole or in part, using the processing system 102 of FIGS. 1 and 2, using the machine learning training and inference system 1000 of FIG. 10, and/or using the processing system 1100 of FIG. 1, and/or the like, including combinations and/or multiples thereof.

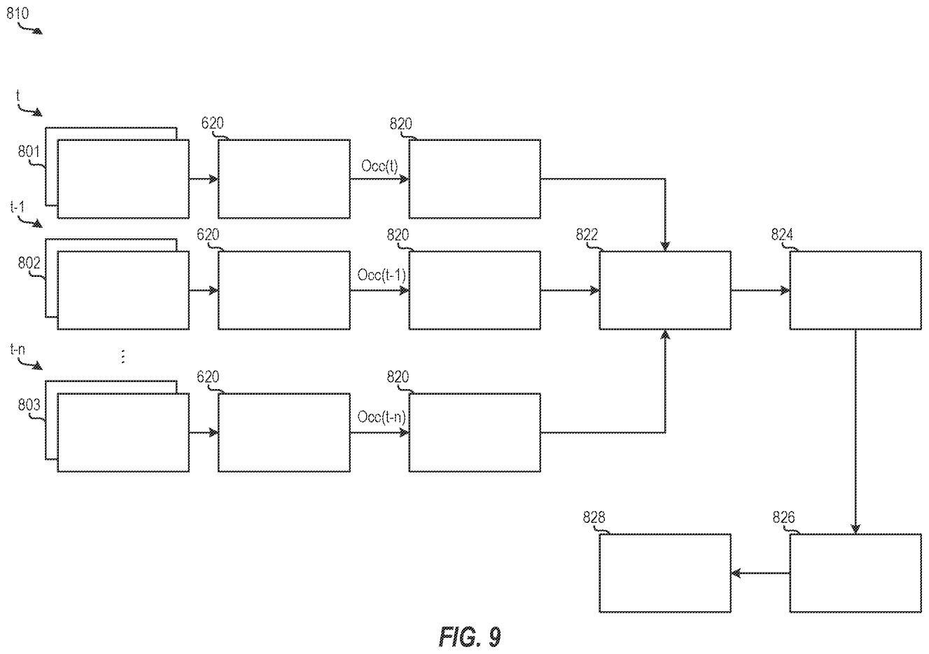

When images are collected, each image may have limited information (e.g., due to occlusion), and inference is noisy in many cases. Aggregation of inferred images provides a certainty measure for each voxel. Voxels inferred as occupied in consecutive images have a relatively higher probability of actually being occupied as opposed to being noise. Voxels near (e.g., within a threshold distance) voxels with a relatively high probability of being static voxels are likely empty but may be wrongly classified due to noise cause by proximity to the static voxels. Static voxels are voxels that are occupied by objects that are not moving with respect to the environment (e.g., a mail box, a parked car, a building, and/or the like, including combinations and/or multiples thereof). In some cases, dynamic objects (e.g., a moving vehicle) are analyzed using single image information. To address these and other concerns, the method 700 provides for noise reduction. Particularly, at block 702, occupied voxels are identified for a time t. At block 704, high probability static voxels are determined using multiple images from sequential time periods (e.g., times t . . . t-n). At block 706, voxels with a high probability of having noise (e.g., greater than a threshold) are removed. Further aspects of the method 700 are discussed in more detail with reference to FIGS. 8 and 9.

FIG. 8 depicts a flow diagram of a method 800 for temporal aggregation with noise reduction according to one or more embodiments. The method 800 can be implemented using any suitable system or device. For example, the method 800 can be implemented, in whole or in part, using the processing system 102 of FIGS. 1 and 2, using the machine learning training and inference system 1000 of FIG. 10, and/or using the processing system 1100 of FIG. 1, and/or the like, including combinations and/or multiples thereof.

As shown in FIG. 8, a first image 801 captured by the camera 104 of the vehicle 100 at a first time t is received. According to one or more embodiments, multiple cameras can be used to capture multiple images at the first time t, as shown in FIG. 5. A second image 802 captured by the camera 104 of the vehicle 100 at a second time t-1 is received. According to one or more embodiments, multiple cameras can be used to capture multiple images at the second time t-1, as shown in FIG. 5. According to one or more embodiments, additional images 803 can be captured at prior points in time, such as at time t-n. The first image 801, the second image 802, and the additional images 803 can be used to generate an occupancy estimation using the occupancy classifier 620 trained as described herein. The occupancy estimation is generated for each of the times t . . . t-n and is expressed as “Occ(t)” . . . “Occ(t-n)” respectively. The occupancy estimation can be expressed as a value [0,1], where higher numbers represent relatively higher probabilities/confidences that a voxel at that time is occupied.

The occupancy estimations for each of the times t . . . t-n are input into a method 810 to identify anchor voxels. Anchor voxels are static voxels with a relatively high probability of occupancy (expressed as “P(occupancy)”). The probability of occupancy is determined using the occupancy estimations for each of the times t . . . t-n, and the probability of occupancy is compared to a threshold. Where it is determined that the probability of occupancy exceeds the threshold, a voxel is determined to be an anchor voxel. The method 810 is shown in more detail in FIG. 9.

In particular, FIG. 9 depicts a flow diagram of the method 810 for identifying anchor voxels according to one or more embodiments. The method 900 can be implemented using any suitable system or device. For example, the method 900 can be implemented, in whole or in part, using the processing system 102 of FIGS. 1 and 2, using the machine learning training and inference system 1000 of FIG. 10, and/or using the processing system 1100 of FIG. 1, and/or the like, including combinations and/or multiples thereof.

The method 810 receives occupancy estimations from the occupancy classifier 620 for the images 801-803 for the times t . . . t-n. The occupancy classifier 620 can generate the occupancy estimations as point clouds for each of the times t . . . t-n. The point clouds of the occupancy estimations are then transformed to global coordinates of a global coordinate system at blocks 820. In particular, the transformation at blocks 820 can use runtime kinematics, which is a GPS-based approach to determine the location and orientation of the vehicle 100 at different times t . . . t-n. According to one or more embodiments, the transformation at block 820 can use visual simultaneous localization and mapping (visual SLAM) techniques to transform the point clouds into the global coordinate system. Once transformed, the individual point clouds can be aggregated into a single, aggregated point could at block 822, which can then be used to perform voxel density estimation at block 824. Voxel density estimation can be performed in different ways, such as by counting the number of voxels that are occupied for the different times t . . . t-n, a kernel density estimation, and/or the like, including combinations and/or multiples thereof. The voxel density estimation at block 824 generates a probability of static object occupancy (expressed as “P(static object occupancy)”), which is the probability regarding whether each voxel in the aggregated point cloud is occupied by a static object. The voxel density estimation is then compared to a density threshold at block 826, where values for voxels that exceed the density threshold are voxels with a high probability of being occupied by static objects at block 828. These are referred to as anchor voxels.

With continued reference to FIG. 8, once the anchor voxels (e.g., the static voxels with a high probability of occupancy by static objects) are identified using the method 810, the method 800 proceeds to extract voxels around the anchor voxels at block 812. Extracting the voxels around the anchor voxels is performed by dilation of the anchor voxels and then subtracting the anchor voxels. The extracted anchor voxels (expressed as “E(anchor voxels)”) from block 812 and the anchor voxels from the method 800 are input into block 814, where noise reduction aggregation is performed. The noise reduction aggregation is performed by subtracting the extracted anchor voxels (E(anchor voxels)) from the union of the occupancy at time t (Occ(t)) and the anchor voxels: Occ(t)∪anchor voxels−E(anchor voxels). The result from the noise reduction aggregation at block 814 is a noise reduced occupancy estimation 816, which marks voxels as empty that were determined to be noisy. This results in an improved 3D scene reconstruction where noisy voxels have been removed.

Additional processes also may be included in one or more of the methods described herein (e.g., the methods 400, 600, 700, 800, 810), and it should be understood that the processes depicted in FIGS. 4 and 6-9 represent illustrations, and that other processes may be added, or existing processes may be removed, modified, or rearranged without departing from the scope of the present disclosure. It should also be understood that the processes depicted in FIGS. 4 and 6-9 may be implemented as programmatic instructions stored on a non-transitory computer-readable storage medium that, when executed by a processor (e.g., the processing device 202 of FIG. 2, the processor(s) 1121 of FIG. 11, and/or the like, including combinations and/or multiples thereof) of a computing system (e.g., the processing system 102 of FIGS. 1 and 2, the processing system 1100 of FIG. 11, and/or the like, including combinations and/or multiples thereof), cause the processor to perform the processes described herein.

One or more embodiments described herein can utilize machine learning techniques to perform tasks, such as temporal multi-frame occupancy estimation. More specifically, one or more embodiments described herein can incorporate and utilize rule-based decision making and artificial intelligence (AI) reasoning to accomplish the various operations described herein, namely temporal multi-frame occupancy estimation. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”) can be used for temporal multi-frame occupancy estimation, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of temporal multi-frame occupancy estimation as described herein.

Systems for training and using a machine learning model are now described in more detail with reference to FIG. 10. Particularly, FIG. 10 depicts a block diagram of components of a machine learning training and inference system 1000 according to one or more embodiments described herein. The system 1000 performs training 1002 and inference 1004. During training 1002, a training engine 1016 trains a model (e.g., the trained model 1018) to perform a task, such as to perform temporal multi-frame occupancy estimation. Inference 1004 is the process of implementing the trained model 1018 to perform the task, such as to perform temporal multi-frame occupancy estimation, in the context of a larger system (e.g., a system 1026). All or a portion of the system 1000 shown in FIG. 10 can be implemented, for example by all or a subset of the processing system 102 of FIGS. 1 and 2 and/or the processing system 1100 of FIG. 11.

The training 1002 begins with training data 1012, which may be structured or unstructured data. According to one or more embodiments described herein, the training data 1012 includes images captured at different times t . . . t-n. The training engine 1016 receives the training data 1012 and a model form 1014. According to one or more embodiments described herein, the model form 1014 represents a base model that is untrained. The model form 1014 can have preset weights and biases, which can be adjusted during training. It should be appreciated that the model form 1014 can be selected from many different model forms depending on the task to be performed. For example, where the training 1002 is to train a model to perform image classification, the model form 1014 may be a model form of a CNN, although other types of model forms and/or algorithms can be implemented.

According to one or more embodiments described herein, the model form 1014 represents an algorithm that can be trained to perform a particular task. In some embodiments, the model form 1014 is an algorithm that can include, for example, supervised learning algorithms, unsupervised learning algorithm, artificial neural network algorithms, association rule learning algorithms, hierarchical clustering algorithms, cluster analysis algorithms, outlier detection algorithms, semi-supervised learning algorithms, reinforcement learning algorithms and/or deep learning algorithms. Examples of supervised learning algorithms can include, for example, AODE; Artificial neural network, such as Backpropagation, Autoencoders, Hopfield networks, Boltzmann machines, Restricted Boltzmann Machines, and/or Spiking neural networks; Bayesian statistics, such as Bayesian network and/or Bayesian knowledge base; Case-based reasoning; Gaussian process regression; Gene expression programming; Group method of data handling (GMDH); Inductive logic programming; Instance-based learning; Lazy learning; Learning Automata; Learning Vector Quantization; Logistic Model Tree; Minimum message length (decision trees, decision graphs, etc.), such as Nearest Neighbor algorithms and/or Analogical modeling; Probably approximately correct learning (PAC) learning; Ripple down rules, a knowledge acquisition methodology; Symbolic machine learning algorithms; Support vector machines; Random Forests; Ensembles of classifiers, such as Bootstrap aggregating (bagging) and/or Boosting (meta-algorithm); Ordinal classification; Information fuzzy networks (IFN); Conditional Random Field; ANOVA; Linear classifiers, such as Fisher's linear discriminant, Linear regression, Logistic regression, Multinomial logistic regression, Naive Bayes classifier, Perceptron, and/or Support vector machines; Quadratic classifiers; k-nearest neighbor; Boosting; Decision trees, such as C4.5, Random forests, ID3, CART, SLIQ, and/or SPRINT; Bayesian networks, such as Naive Bayes; and/or Hidden Markov models. Examples of unsupervised learning algorithms can include Expectation-maximization algorithm; Vector Quantization; Generative topographic map; and/or Information bottleneck method. Examples of artificial neural network can include Self-organizing maps. Examples of association rule learning algorithms can include Apriori algorithm; Eclat algorithm; and/or FP-growth algorithm. Examples of hierarchical clustering can include Single-linkage clustering and/or Conceptual clustering. Examples of cluster analysis can include K-means algorithm; Fuzzy clustering; DBSCAN; and/or OPTICS algorithm. Examples of outlier detection can include Local Outlier Factors. Examples of semi-supervised learning algorithms can include Generative models; Low-density separation; Graph-based methods; and/or Co-training. Examples of reinforcement learning algorithms can include Temporal difference learning; Q-learning; Learning Automata; and/or SARSA. Examples of deep learning algorithms can include Deep belief networks; Deep Boltzmann machines; Deep Convolutional neural networks; Deep Recurrent neural networks; and/or Hierarchical temporal memory.

According to one or more embodiments described herein, the model form 1014 is a foundational model that is trained on a wide variety of generalized, unlabeled training data to perform one or more different general tasks, such as generating content (text, images, etc.), performing natural language processing, and/or the like including combinations and/or multiples thereof. In the case of the model form 1014 being a foundational model, the training 1002 can include tuning the foundational model (e.g., the model form 1014) using the training data 1012. Tuning the foundational model provides the benefits of the broad capabilities of the foundational model while enabling the foundational model to be customized using training data (e.g., the training data 1012) related to a particular task or environment to which the foundational modal is then applied. In this way, the training 1002 need not train a new model from scratch, which is time consuming and resource intensive.

The training 1002 can be supervised learning, semi-supervised learning, unsupervised learning, reinforcement learning, and/or the like, including combinations and/or multiples thereof. For example, supervised learning can be used to train a machine learning model to classify an object of interest in an image. To do this, the training data 1012 includes labeled images, including images of the object of interest with associated labels (ground truth) and other images that do not include the object of interest with associated labels. According to one or more embodiments, the ground truth can include data from other sensors, such as radar and/or LiDAR sensors. In this example, the training engine 1016 takes as input a training image from the training data 1012, makes a prediction for classifying the image, and compares the prediction to the ground truth (e.g., the data from the radar and/or LiDAR sensors), which provides actual occupancy information. The training engine 1016 then adjusts weights and/or biases of the model based on results of the comparison, such as by using backpropagation. The training 1002 may be performed multiple times (referred to as “epochs”) until a suitable model is trained (e.g., the trained model 1018).

Once trained, the trained model 1018 can be used to perform inference 1004 to perform a task, such as to perform temporal multi-frame occupancy estimation. The inference engine 1020 applies the trained model 1018 to new data 1022 (e.g., real-world, non-training data). For example, if the trained model 1018 is trained to classify images of a particular object, such as a chair, the new data 1022 can be an image of a chair that was not part of the training data 1012. In this way, the new data 1022 represents data to which the model 1018 has not been exposed. The inference engine 1020 makes a prediction 1024 (e.g., a voxel occupancy estimation; a classification of an object in an image of the new data 1022) and passes the prediction 1024 to the system 1026 (e.g., the occupancy engine 210 of FIG. 2). The system 1026 can, based on the prediction 1024, taken an action, perform an operation, perform an analysis, and/or the like, including combinations and/or multiples thereof. In some embodiments, the system 1026 can add to and/or modify the new data 1022 based on the prediction 1024.

In accordance with one or more embodiments, the predictions 1024 generated by the inference engine 1020 are periodically monitored and verified to ensure that the inference engine 1020 is operating as expected. Based on the verification, additional training 1002 may occur using the trained model 1018 as the starting point. The additional training 1002 may include all or a subset of the original training data 1012 and/or new training data 1012. In accordance with one or more embodiments, the training 1002 includes updating the trained model 1018 to account for changes in expected input data.

It is understood that one or more embodiments described herein is capable of being implemented in conjunction with any other type of computing environment now known or later developed. For example, FIG. 11 depicts a block diagram of a processing system 1100 for implementing the techniques described herein. In accordance with one or more embodiments described herein, the processing system 1100 is an example of a cloud computing node of a cloud computing environment. In examples, processing system 1100 has one or more central processing units (referred to also as “processors” or “processing resources” or “processing devices”) 1121a, 1121b, 1121c, etc. (collectively or generically referred to as processor(s) 1121 and/or as processing device(s)). In aspects of the present disclosure, each processor 1121 can include a reduced instruction set computer (RISC) microprocessor. Processors 1121 are coupled to a system memory 1122 and/or various other components via a system bus 1133. The system memory 1122 can include one or more temporary and/or persistent memory devices, such as a random access memory (RAM) 1123, a read-only memory (ROM) 1124, and/or the like, including combinations and/or multiples thereof. The system bus 1133 may include a basic input/output system (BIOS), which controls certain basic functions of processing system 1100.

Further depicted are an input/output (I/O) adapter 1127 and a network adapter 1126 coupled to system bus 1133. I/O adapter 1127 may be a small computer system interface (SCSI) adapter that communicates with a hard disk 1135 and/or a storage device 1136 or any other similar component. I/O adapter 1127, hard disk 1135, and storage device 1136 are collectively referred to herein as mass storage 1134. Operating system 1140 for execution on processing system 1100 may be stored in mass storage 1134. The network adapter 1126 interconnects system bus 1133 with an outside network 1138 enabling processing system 1100 to communicate with other such systems.

A display (e.g., a display monitor) 1139 is connected to system bus 1133 by display adapter 1132, which may include a graphics adapter to improve the performance of graphics intensive applications and a video controller. In one aspect of the present disclosure, adapters 1126, 1127, and/or 1132 may be connected to one or more I/O buses that are connected to system bus 1133 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 1133 via user interface adapter 1128 and display adapter 1132. A keyboard 1129, mouse 1130, and speaker 1131 may be interconnected to system bus 1133 via user interface adapter 1128, which may include, for example, a Super I/O chip integrating multiple device adapters into a single integrated circuit.

In some aspects of the present disclosure, processing system 1100 includes a graphics processing unit (GPU) 1137. Graphics processing unit 1137 is a specialized electronic circuit designed to manipulate and alter memory to accelerate the creation of images in a frame buffer intended for output to a display. In general, graphics processing unit 1137 is very efficient at manipulating computer graphics and image processing, and has a highly parallel structure that makes it more effective than general-purpose CPUs for algorithms where processing of large blocks of data is done in parallel.

Thus, as configured herein, processing system 1100 includes processing capability in the form of processors 1121, storage capability including the system memory 1122 and mass storage 1134, input means such as keyboard 1129 and mouse 1130, and output capability including speaker 1131 and display 1139. In some aspects of the present disclosure, a portion of system memory 1122 and mass storage 1134 collectively store the operating system 1140 to coordinate the functions of the various components shown in processing system 1100.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method comprising:
receiving a first image captured by a camera of a vehicle at a first time t;
receiving a second image captured by the camera of the vehicle at a second time t-1;
projecting each of a plurality of world voxels to the camera at the first time t and the second time t-1;
aggregating voxel features for the plurality of world voxels for the first image and the second image; and
training an occupancy classifier using the aggregated voxel features.

2. The computer-implemented method of claim 1, wherein projecting each of a plurality of world voxels to the camera at the first time t and the second time t-1 comprises:
extracting a feature from the first image captured at the first time t;
projecting a voxel grid definition in a local coordinate system at the first time t to the first image; and
performing feature sampling for the first image based at least in part on results of the extracting and results of the projecting.

3. The computer-implemented method of claim 2, wherein projecting each of a plurality of world voxels to the camera at the first time t and the second time t-1 further comprises:
extracting the feature from the second image captured at the second time t-1;
projecting the voxel grid definition in the local coordinate system at the second time t-1 to the second image; and
performing feature sampling for the second image based at least in part on results of the extracting and results of the projecting.

4. The computer-implemented method of claim 3, wherein projecting each of a plurality of world voxels to the camera at the first time t and the second time t-1 further comprises:
performing voxel feature aggregation based at least in part on results of the feature sampling for the first image and results of the feature sampling for the second image; and
wherein training the occupancy classifier comprises generating an occupancy estimation network based at least in part on the voxel feature aggregation.

5. The computer-implemented method of claim 4, wherein the occupancy estimation network is generated using voxel grid features.

6. The computer-implemented method of claim 4, wherein the voxel feature aggregation is performed using at least one of an average, a weighted average, or a deformable attention.

7. The computer-implemented method of claim 1, wherein training the occupancy classifier comprises comparing voxel grid features to a ground truth value to reduce a cost function associated with the occupancy classifier.

8. The computer-implemented method of claim 7, wherein the ground truth value is captured by a sensor associated with the vehicle.

9. The computer-implemented method of claim 8, wherein the sensor is one of a range detection and ranging (radar) sensor and a light detecting and ranging (LiDAR) sensor.

10. A vehicle comprising:
a camera capturing a first image at a first time t and a second image at a second time t-1; and
a processing system, the processing system comprising:
a memory comprising computer readable instructions; and
a processing device for executing the computer readable instructions, the computer readable instructions controlling the processing device to perform operations comprising:
generating, using a trained occupancy classifier, a first occupancy estimation for voxels of the first image captured at the first time t;
generating, using the trained occupancy classifier, a second occupancy estimation for voxels of the second image captured at the second time t-1;
identifying, using the first occupancy estimation and the second occupancy estimation, anchor voxels, the anchor voxels being voxels of the first image and the second image that are static and have a probability of occupancy exceeding a threshold;
extracting, from the anchor voxels, voxels of the first image and the second image within a threshold distance of the anchor voxels as extracted voxels; and
generating a noise reduced occupancy estimation for voxels of the first image and voxels of the second image using the anchor voxels and the extracted voxels within the threshold distance of the anchor voxels.

11. The vehicle of claim 10, wherein identifying the anchor voxels comprises:
transforming the first occupancy estimation to first coordinates of a global coordinate system to generate a first point cloud;
transforming the second occupancy estimation to second coordinates of the global coordinate system to generate a second point cloud; and
aggregating the first point cloud and the second point cloud into a combined point cloud.

12. The vehicle of claim 11, wherein identifying the anchor voxels further comprises:
estimating a voxel density of the combined point cloud;
comparing the voxel density to a density threshold; and
identifying as the anchor voxels those voxels of the combined point cloud that exceed the density threshold.

13. The vehicle of claim 12, wherein estimating the voxel density is based on a count of a number of times each voxel is occupied for the first time t and the second time t-1.

14. The vehicle of claim 12, wherein estimating the voxel density is based on a kernel density estimation.

15. The vehicle of claim 11, wherein transforming the first occupancy estimation to the first coordinates and transforming the second occupancy estimation to the second coordinates comprises applying runtime kinematics.

16. The vehicle of claim 11, wherein transforming the first occupancy estimation to the first coordinates and transforming the second occupancy estimation to the second coordinates comprises applying visual simultaneous localization and mapping.

17. A computer program product comprising a computer readable storage medium having program instructions embodied therewith, the program instructions executable by at least one processor to cause the at least one processor to perform operations comprising:
generating, using a trained occupancy classifier, a first occupancy estimation for voxels of a first image captured by a camera of a vehicle at a first time t;
generating, using the trained occupancy classifier, a second occupancy estimation for voxels of a second image captured by the camera of the vehicle at a second time t-1;
identifying, using the first occupancy estimation and the second occupancy estimation, anchor voxels, the anchor voxels being voxels of the first image and the second image that are static and have a probability of occupancy exceeding a threshold;
extracting, from the anchor voxels, voxels of the first image and the second image within a threshold distance of the anchor voxels as extracted voxels; and
generating a noise reduced occupancy estimation for voxels of the first image and voxels of the second image using the anchor voxels and the extracted voxels within the threshold distance of the anchor voxels.

18. The computer program product of claim 17, wherein identifying the anchor voxels comprises:
transforming the first occupancy estimation to first coordinates of a global coordinate system to generate a first point cloud;
transforming the second occupancy estimation to second coordinates of the global coordinate system to generate a second point cloud; and
aggregating the first point cloud and the second point cloud into a combined point cloud.

19. The computer program product of claim 18, wherein identifying the anchor voxels further comprises:
estimating a voxel density of the combined point cloud;
comparing the voxel density to a density threshold; and
identifying as the anchor voxels those voxels of the combined point cloud that exceed the density threshold.

20. The computer program product of claim 19, wherein estimating the voxel density is based on a count of a number of times each voxel is occupied for the first time t and the second time t-1.
